(19) United States
(12) Patent Application Publication
(10) Pub. No.: US 2024/0077210 A1
(43) Pub. Date: Mar. 7, 2024

(54) OVEN BROILER DRAWER

(71) Applicant: CHAR Products LLC, North Las Vergas, NV (US)

(72) Inventor: William P. Blazvick, Las Vegas, NV (US)

(21) Appl. No.: 18/388,420

(22) Filed: Nov. 9, 2023

Related U.S. Application Data
(63) Continuation of application No. 17/157,042, filed on Jan. 25, 2021, now Pat. No. 11,852,348.
Application No. 17/157,042 is a continuation of application No. 16/266,283, filed on Feb. 4, 2019, now Pat. No. 10,948,197.
(60) Provisional application No. 62/626,819, filed on Feb. 6, 2018.

(51) Int. Cl. F24C 15/16

(52) U.S. Cl. CPC F24C 15/16

(57) ABSTRACT

An oven broiler drawer assembly includes a housing. A drawer assembly sized to be substantially received by an interior region of the housing includes an upper drawer and a lower drawer. The lower drawer is movably mounted to the upper drawer so that the lower drawer may be moved with respect to the upper drawer between a closed position and an opened position. A slide assembly operatively associated with the housing and the upper drawer allows the upper drawer to be moved with respect to the housing between a retracted position and an extended position. A gas manifold assembly is mounted to the housing so that it is located at a position below a grate provided on the upper drawer when the upper drawer is in the retracted position.

### CROSS-REFERENCE TO RELATED APPLICATIONS

This application is a continuation of co-pending U.S. patent application Ser. No. 17/157,042, filed on Jan. 25, 2021, now allowed, which is a continuation of U.S. patent application Ser. No. 16/266,283, filed on Feb. 4, 2019, now U.S. Pat. No. 10,948,197, which claims the benefit of U.S. Provisional Patent Application No. 62/626,819, filed on Feb. 6, 2018, all of which are hereby incorporated herein by reference for all that they disclose.

### FIELD OF THE INVENTION

This invention relates to charbroilers in general and more specifically to a broiler drawer for placement in a masonry or ceramic oven.

### BACKGROUND OF THE INVENTION

With a growing trend toward open kitchens, more and more restaurants are incorporating brick, stone or ceramic wood-fired or gas-fired pizza ovens in their kitchens, along with a host of other specialized professional cooking equipment, such as charbroilers. Pizza ovens (which can be used for foods other than pizza) operate at extremely high temperatures in the range of around 700° F. (371.1° C.) to around 1,000° F. (537.8° C.). Charbroilers are standalone range or countertop models; sometimes a lower oven may be incorporated with the range models.

### SUMMARY OF THE INVENTION

An oven broiler drawer assembly may include a housing defining an interior region therein. A drawer assembly sized to be substantially received by the interior region defined by the housing may include an upper drawer and a lower drawer. The upper drawer may define at least an open top portion and an open bottom portion, the open top portion being sized to receive a grate thereon. The lower drawer may define at least an open top portion and a closed bottom portion. The lower drawer is movably mounted to the upper drawer so that the lower drawer may be moved with respect to the upper drawer between a closed position and an opened position. A slide assembly operatively associated with the housing and the upper drawer allows the upper drawer to be moved with respect to the housing between a retracted position and an extended position. A gas manifold assembly is mounted to the housing so that it is located at a position below the grate when the upper drawer is in the retracted position.

### BRIEF DESCRIPTION OF THE DRAWINGS

Illustrative and presently preferred exemplary embodiments of the invention are shown in the drawings in which:

FIG. 1 is an isometric view of the oven broiler drawer of the present invention;

FIG. 2 contains (A) a front view, (B) an isometric view, (C) a bottom view and (D) a side view of an embodiment of the oven broiler drawer of the present invention;

FIG. 3 is an (A) isometric view and (B) a side view of a lower drawer of an embodiment of the present invention;

FIG. 4 are isometric views of a slide bracket and a slide bracket as installed in the housing in an embodiment of the present invention;

FIG. 5 is a detailed view of a slide bracket;

FIG. 6 is an isometric view of an upper drawer of an embodiment of the present invention;

FIG. 7 shows several views of a handle base of the present invention;

FIG. 8 is an exploded view of an embodiment of the oven broiler drawer of the present invention;

FIG. 9 is an isometric view of a roller assembly of an embodiment of the present invention, as well as a roller;

FIG. 10 is an isometric view of an embodiment of a slide assembly of the present invention;

FIG. 11 shows multiple views of a roller;

FIG. 12 is (A) an isometric view of a support assembly of a gas manifold assembly, (B) a side view of a support assembly of a gas manifold assembly, and (C) a front view of a housing back showing a support assembly of a gas manifold assembly as installed in an embodiment of the present invention;

FIG. 13 is (A) an isometric view and (B) a side view of a gas supply assembly in an embodiment of the present invention;

FIG. 14 is isometric view of pipe burners of an embodiment of the present invention;

FIG. 15 contains multiple views of pipe burners of an embodiment of the present invention;

FIG. 16 contains multiple views of pipe burners of another embodiment of the present invention;

FIG. 17 shows an isometric view, top view, side view, and end view of a radiant deflector in an embodiment of the present invention;

FIG. 18 is an isometric view of an embodiment of the oven broiler drawer of the present invention showing the radiant deflector as installed in the drawer assembly and housing;

FIG. 19 contains multiple views of a burner orifice of an embodiment of the present invention; and

FIG. 20 (A) is an isometric view of portions of the oven broiler drawer with the housing removed and (B) an enlarged portion of the encircled area in (A) more clearly showing the engagement of the finger member with the slot defined by the front plate of the lower drawer.

### DETAILED DESCRIPTION OF THE PREFERRED EMBODIMENTS

The present invention comprises a charbroiler drawer or oven broiler drawer 10 as it may be connected to a source (not shown) of natural gas although other gas sources, such as propane of liquified petroleum gas (LPG), could be used.

Oven broiler drawer 10 solves several problems identified by the inventor for extending various drawers, racks or shelves of a charbroiler. They include heat, weight and limited extension. Charbroilers may have only a metal on metal slide for a grease or crumb tray located below the burners, but not a slide assembly for moving the cooking surface. Slide assemblies are more commonly found in conventional ovens; however, such slide assemblies are often limited in their design because the heat source for cooking is right next to the slide assemblies which can cause deterioration. In addition, prior slide assemblies may not be able to support the weight of the cast-iron and steel components required for high temperature cooking of a charbroiler or oven broiler drawer 10. Finally, known slide assemblies are not capable of being fully extended or are limited to over travel for exhaust hood capture, which can lead to health hazards and injuries while cooking. Moreover, there is no known charbroiler for incorporation into a masonry or brick pizza oven. The present oven broiler drawer 10 solves these problems identified by the inventor.

The present invention will now be described with reference to the drawings. Oven broiler drawer 10 comprises drawer assembly 12, housing 18, slide assembly 14 and gas manifold assembly 16. In embodiments shown, housing 18 defines an interior region 11 therein and provides a support base for oven broiler drawer 10. Drawer assembly 12 is sized to be substantially received by the interior region 11 of housing 18. Drawer assembly 12 is inserted into housing 18 in a nesting cooperative arrangement so that drawer assembly 12 can be extended in various embodiments via slide assembly 14 without disturbing gas manifold assembly 16 even during active grilling operations.

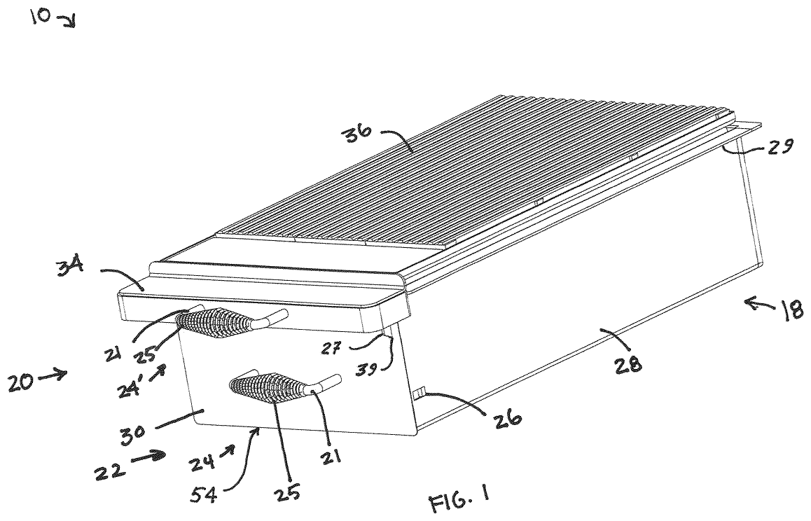

As shown in FIGS. 1-2, 3 and 6, drawer assembly 12 comprises upper drawer 20 and lower drawer 22, both of which fit within housing 18 in a nesting cooperative arrangement in which, among other things, upper drawer 20 supports a cooking or grilling surface (e.g., grate 36), while lower drawer 22 allows for the collection of grease and crumbs from food being grilled.

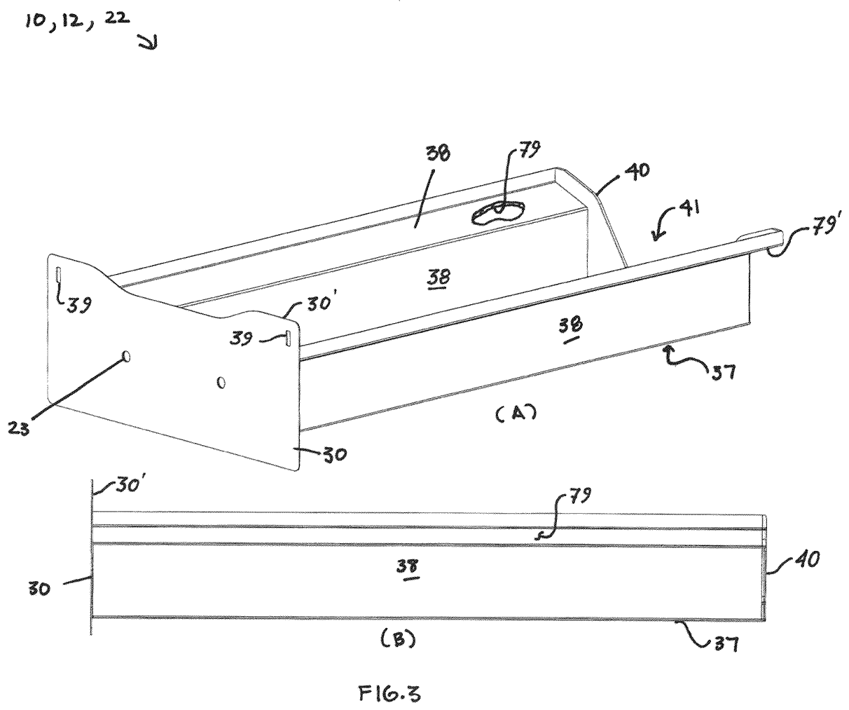

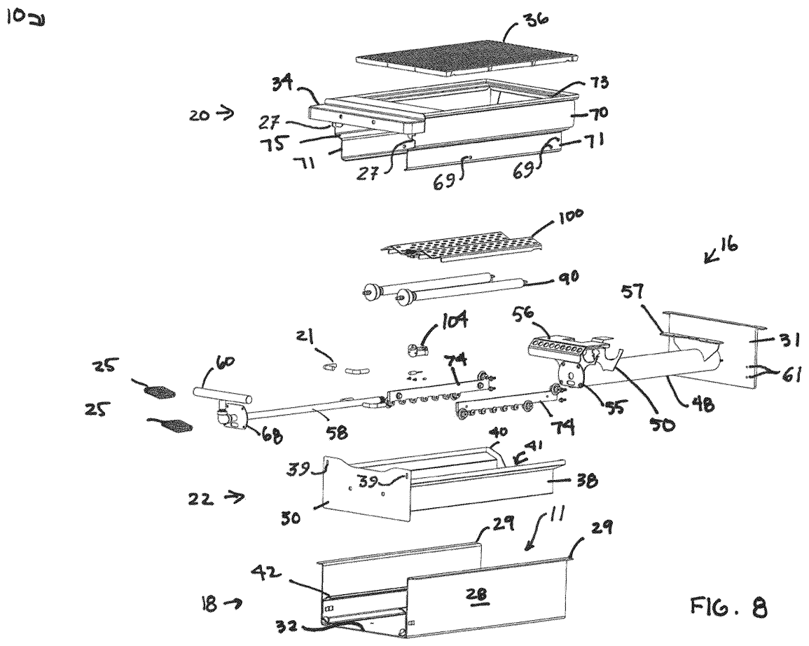

Lower drawer 22 is used to collect grease and crumbs that fall from grate 36 during the charbroiling process. Lower drawer 22 comprises an open-at-the top box, i.e., having an open top portion 17 and a closed bottom portion 19, defined by lower drawer front plate 30, lower drawer sides 38 and lower drawer back 40, in which the two lower drawer sides 38 are in spaced, substantially parallel relation to one another with lower drawer front plate 30 and lower drawer back 40 being attached at either end, substantially perpendicularly to lower drawer sides 38. FIGS. 3, 8. Sides 38 of lower drawer 22 are fashioned to form a bearing surface 79. Lower drawer 22 also includes bottom 37 to which lower drawer front plate 30, lower drawer sides 38 and lower drawer back 40 are attached (e.g., welded), but this is not shown. Lower drawer back 40 comprises cut-out portion 41, which in one embodiment is generally U-shaped (or V-shaped) to accommodate or clear gas manifold assembly 16, as is discussed below, although other shapes could be used. In an embodiment, lower drawer 22 fits within housing 18 as shown in FIG. 8.

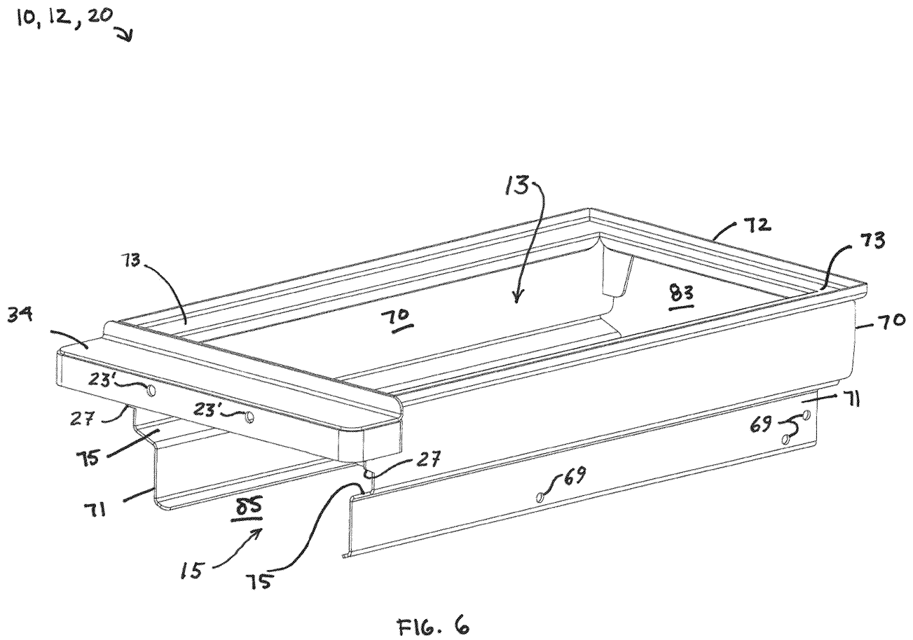

With reference to FIGS. 1, 2, 6, 8, upper drawer 20 comprises front shelf 34, upper drawer back 72 and upper drawer sides 70 which define insert 73 that provides a support surface for grate 36 upon which cooking would take place. Upper drawer 20 comprises an open-at-the-top-and-bottom box, i.e., having an open top portion 13 and an open bottom portion 15, in which upper drawer sides 70 are in spaced, substantially parallel relation to one another with front shelf 34 and upper drawer back 72 being attached at either end and substantially perpendicularly to upper drawer sides 70. Upper drawer back 72 may be described as a link tying the upper drawer sides 70 together, defining upper drawer back open portion 83; thus, the back of the upper drawer 20 is largely open but for the upper drawer back 72, as shown in FIG. 6. Front shelf 34 may also be described as a link tying upper drawer sides 70 together, defining upper drawer front open portion 85; thus, the front of upper drawer 20 is also substantially open but for front shelf 34. Upper drawer sides 70 also comprise respective lower portions 71. In an embodiment shown, each lower portion 71 is fashioned to form a bearing surface 75 which is configured to slidably receive bearing surface 79 formed by each side 38 of lower drawer 22. Lower drawer 22 is therefore moveably mounted to upper drawer 20 so that lower drawer 22 may be moved with respect to upper drawer 20 between a closed position 52, illustrated in FIGS. 1, 2, and 18, and an opened position (not specifically shown). Lower portion 71 comprises holes 69 which are used to secure caster or roller assembly 74 of slide assembly 14.

In addition to being moveably mounted with respect to upper drawer 20, and as well be described in greater detail below, lower drawer 22 may also be releasably engagable with the upper drawer 20 so that when the lower drawer 22 is engaged with upper drawer 20, lower drawer 22 will move along with upper drawer 20 when upper drawer 20 is moved to the extended position. When lower drawer 22 is released from upper drawer 20, lower drawer 22 can be moved to the opened position with respect to upper drawer 20.

With reference now primarily to FIGS. 1, 2, 3, 6, and 20, each side member 70 of upper drawer 20 may be provided with a finger member 27 sized to be received by a corresponding slot 39 defined by front portion or plate 30 of lower drawer 22. When finger members 27 of upper drawer 20 are engaged with their respective slots 39 in lower drawer 22, lower drawer 22 will be engaged with upper drawer 20. Lower drawer 22 will then move along with upper drawer 20 when upper drawer 20 is moved to the extended position. However, because of the engagement of lower drawer 22 with upper drawer 20, upper drawer 20 will move along with lower drawer 22 when lower drawer 22 is extended from the closed position 52 to the opened position.

When finger members 27 of upper drawer 20 are disengaged from their respective slots 39 in lower drawer 22, lower drawer 22 will be released from upper drawer 20. Therefore, upper drawer 22 may be extended and retracted independently from upper drawer 20. However, even when lower drawer 22 is released from upper drawer 20, extension of the upper drawer 20 will also cause lower drawer 22 to move along with upper drawer 20. This is due to the abutting relationship between front portion or plate 30 of lower drawer 22 and side members 70 of upper drawer 20. But it should be noted that upper drawer 20 could be returned to the retracted position 53 without causing the lower drawer 22 to follow along (i.e., move to the closed position 52). The lower drawer 22 would remain in the opened position.

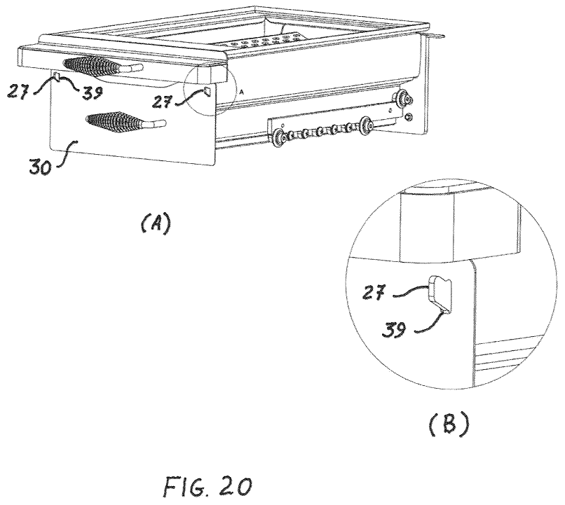

In the particular embodiments shown and described herein, finger members 27 are angled slightly upwardly, as best seen in FIG. 20, and at least the front portion 30 of lower drawer 22 is moveable with respect to at least the front portion 34 of upper drawer 20 between a lowered position 54 (illustrated in FIGS. 1, 2, 18, and 20) and a raised position (not specifically shown). The relative movement is a consequence of the engagement of sliding surfaces 75 and 79, which permit lower drawer 22 to be elevated or raised somewhat with respect to upper drawer 20. Therefore finger members 27, which are angled slightly upwardly, may be engaged with their respective slots 39 when lower drawer 22 is in the lowered position 54 and disengaged from slots 39 by lifting up on lower drawer 22 (e.g., via handle 24) to move it to the raised position and by also slightly pulling forward on lower drawer 22.

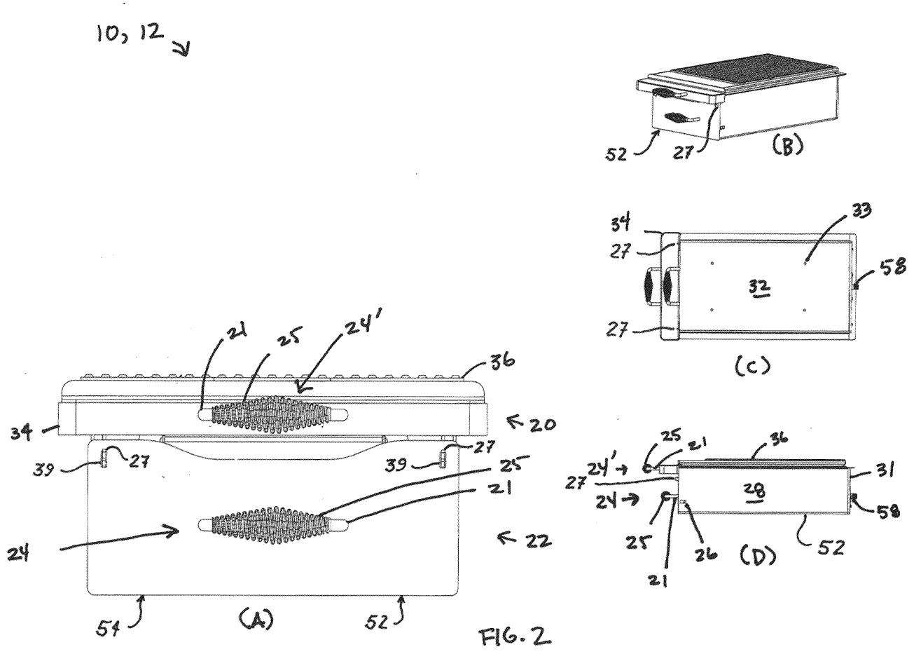

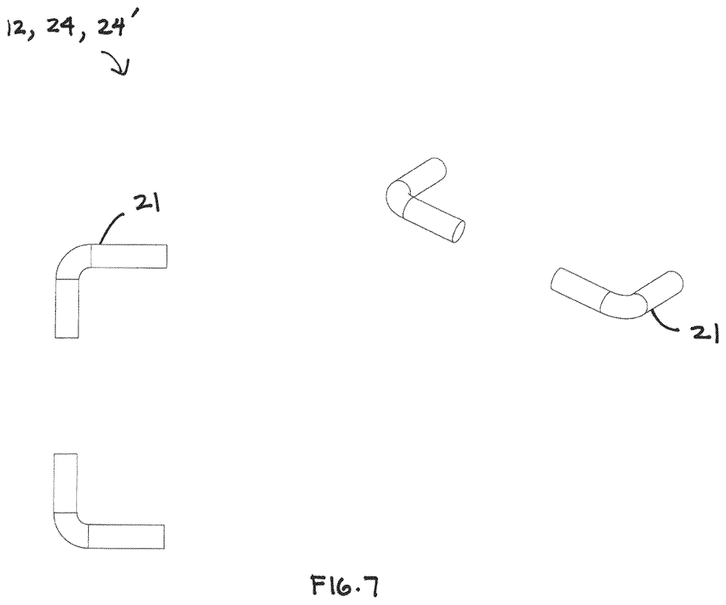

As best seen in FIGS. 1, 2, handles 24, 24′ are attached (e.g., welded) to both lower drawer 22 and upper drawer 20, respectively. Handle 24, 24′ comprises handle base 21 (FIG. 7) and spring grip 25. In the case of upper drawer 20, handle 24′ is attached to front shelf 34 in the location of holes 23′. FIG. 6. In the case of lower drawer 22, handle 24 is attached to front plate 30 in the location of holes 23. In an embodiment, handle base 21 is inserted into holes 23, 23′ and welded to front shelf 34 and front plate 30 on the back side; however, other attachment configurations are possible as would be apparent to one of ordinary skill in the art after becoming familiar with the teachings of the present invention.

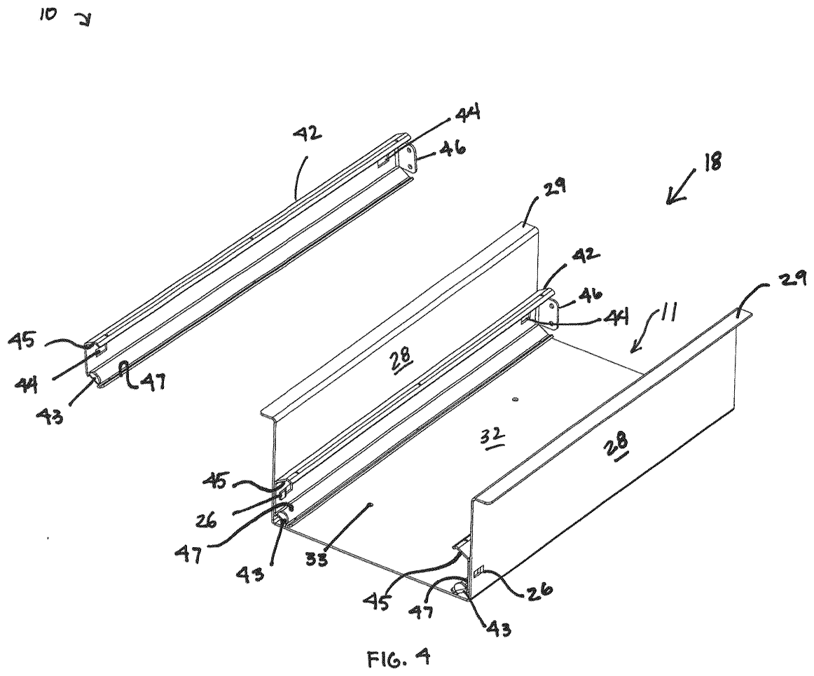

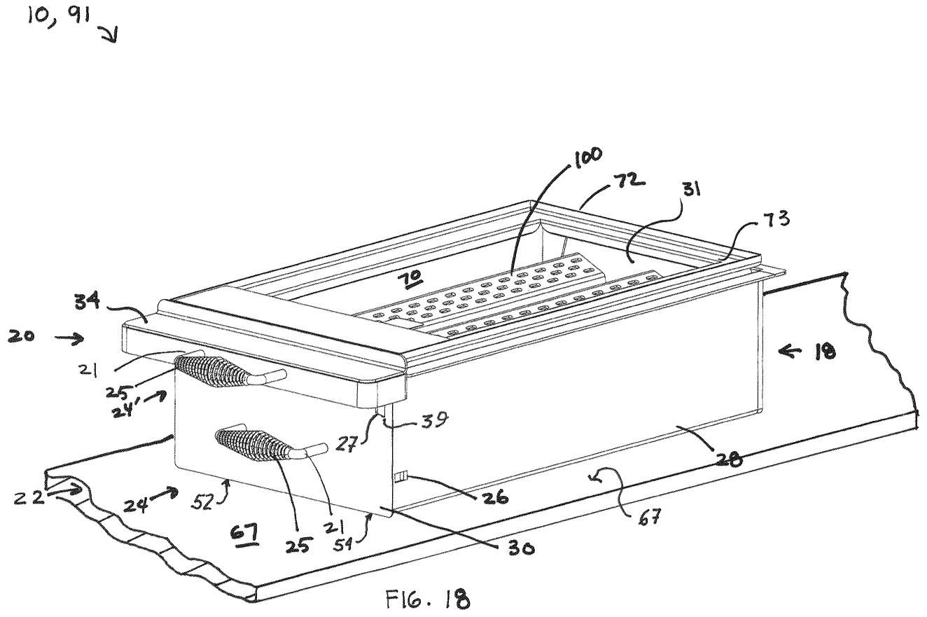

As briefly mentioned above, housing 18 defines an interior region 11 therein that is sized to substantially receive drawer assembly 12, i.e., comprising upper drawer 20 and lower drawer 22, as well as gas manifold assembly 16 and part of slide assembly 14. FIG. 8. As shown in FIG. 4, housing 18 comprises housing sides 28 and bottom 32. Housing sides 28 are in spaced, substantially parallel relation to one another and substantially perpendicular to bottom 32. Housing sides 28 comprise clip 26 and shelf or lip 29, which is connected to housing side 28. In the embodiment shown, clip(s) 26 are used to attach slide brackets 42 (which form part of slide assembly 14) to the interior of housing sides 28, although other attachment means are possible. In the embodiment shown, bottom 32 comprises holes 33. Holes 33 can be used for bolting or otherwise securing oven broiler drawer 10 to a base (e.g., floor 67 of a pizza oven or other ovens) for stability. See FIG. 18. As seen in FIG. 8, housing 18 further comprises housing back 31, which is used to support gas manifold assembly 16. Housing back 31 is attached (e.g., welded) to housing sides 28 and bottom 32 in perpendicular relation to those components. As shown in FIGS. 4 and 8, housing 18 is substantially open at the top and configured to receive lower drawer 22, gas manifold assembly 16, and upper drawer 20, including grate 36. Thus, housing 18 may be described as a generally U-shaped box open at the top and in the front.

In an embodiment, lower drawer 22, upper drawer 20 and housing 18 are each fashioned from a single piece of stainless steel, cut and bent to form the final shape of each component with the connections and attachments being made by welding, unless otherwise indicated, but the invention should not be viewed as being limited in that respect. In another embodiment, each element comprising lower drawer 22, upper drawer 20 and housing 18 could be fashioned individually and welded together. All parts are stainless steel, unless otherwise indicated. In an embodiment, type 304 stainless steel was used; however, type 316 stainless steel could also be used, along with any other suitable material that is rust-resistant and could withstand the very high heat of burners 90. In one embodiment, grate 36 is made out of cast-iron, but other materials suitable for high heat could also be used.

As best seen in FIG. 8, housing 18 comprises the support base for oven broiler drawer 10, into which is inserted lower drawer 22, gas manifold assembly 16, and upper drawer 20, including grate 36. In an embodiment shown, upper drawer 20 and lower drawer 22 are inserted into housing 18 in a nesting, cooperative arrangement. More specifically, lower drawer 22 is moveably mounted to upper drawer via the sliding engagement of mating surfaces 75 and 79, whereas upper drawer 20 is moveably mounted to housing 18 via slide assemblies 14. Components of slide assembly 14 are variously attached to housing 18 and upper drawer 20 in cooperative fashion to permit upper drawer 20 to be extended via operation of slide assembly 14 when a user pulls on handle 24′ (or retracted via operation of slide assembly 14 when the user pushes on handle 24′). In an embodiment, extending upper drawer 20 will cause lower drawer 22 to follow along and be pulled out as well in trailing fashion.

Slide assembly 14 and its operation will now be discussed with reference to the drawings. FIGS. 4, 5, 8-11. Slide assembly 14 comprises slide bracket or track member 42 and caster or roller assembly 74 which is configured to operate cooperatively with slide bracket or track member 42 to allow upper drawer 20 to be extended or retracted.

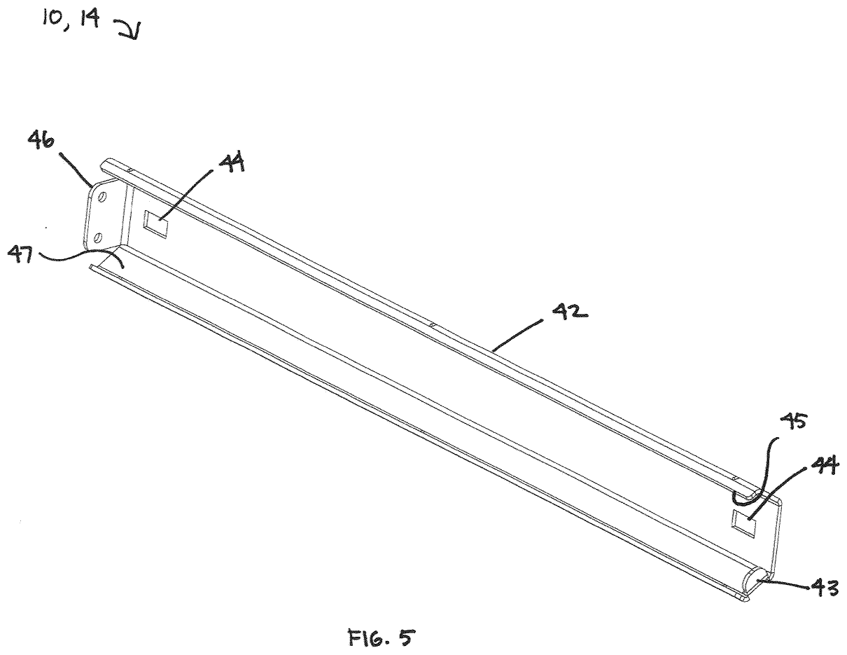

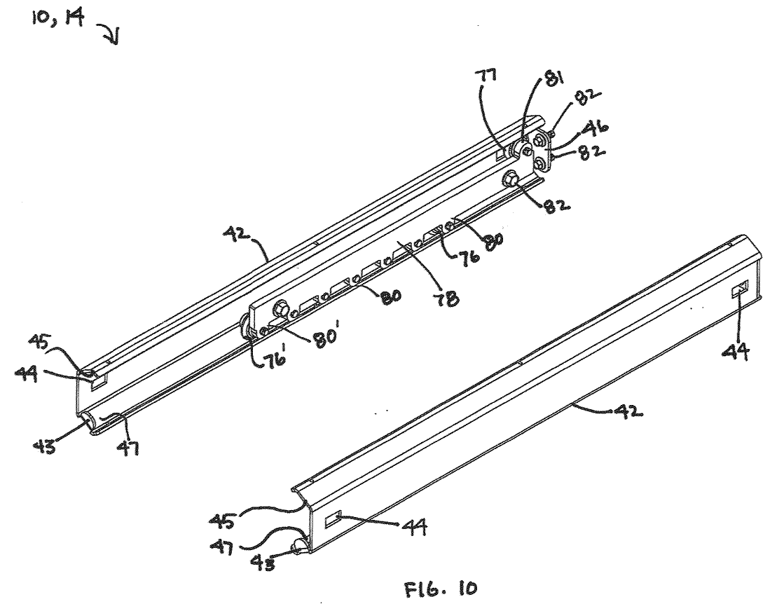

Track members 42 comprise upper track 45, lower track 47, as well as flange 46, slide or stop member 43 and holes 44; track members 42 are configured to receive roller assembly 74. See FIG. 10. As shown in FIGS. 5 and 10, each track member 42 comprises a generally C-shaped channel with upper track 45 and lower track 47 being oriented generally parallel to one another. Flange 46 is attached in a general perpendicular orientation to upper track 45 and lower track 47. Stop member 43 is generally perpendicular to lower track 47. In one embodiment, track member 42 is fashioned from a single sheet of stainless steel, cut and bent to the desired shape as shown in FIG. 5, although the invention should not be viewed as being limited in this respect. In an embodiment shown in FIG. 4, track members 42 are attached to the interior of housing sides 28 by inserting clips 26 of housing sides 28 into holes 44 of track members 42; however, other attachment means could be used. Flange 46 is configured to be bolted to housing back 31 using bolts 82 inserted in holes 61.

Each caster or roller assembly 74 in turn is mounted to the exterior of respective upper drawer sides 70. When engaged with the track members 42, the roller assemblies 74 permit upper drawer 20 and, optionally, lower drawer 22, to be pulled out or pushed in (e.g., extended or retracted). Each caster or roller assembly 74 comprises one or more lower castors or rollers 76, 76′, upper caster or roller 77 and caster or roller support member 78. Lower rollers 76, 76′ and upper roller 77 are both operably connected to roller support member 78, which further comprises a plurality of lower roller mounting locations 80, screws 84 and bolt 82. FIGS. 8-11.

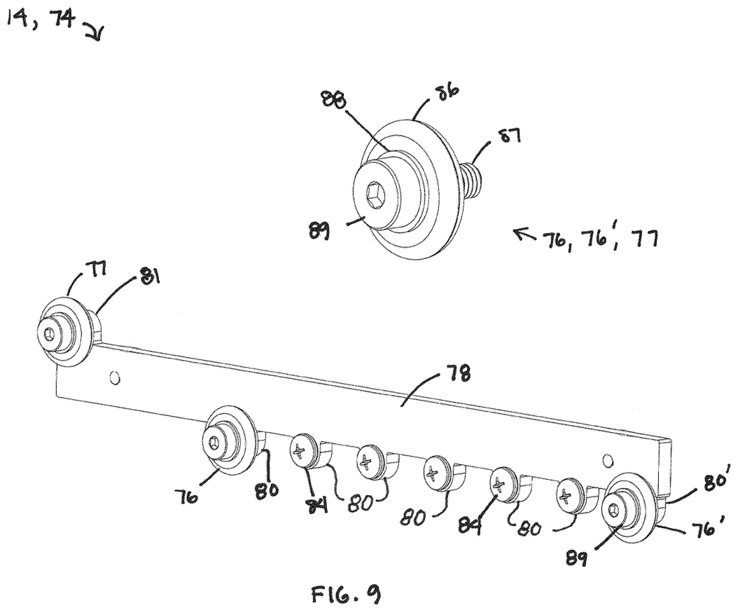

As best seen in FIGS. 9-11, each of lower rollers 76, 76′ and upper roller 77 comprise wheel 86, washer 88, shoulder screw 89 and threaded portion 87, which are assembled in the manner shown. In an embodiment shown, lower rollers 76, 76′ and upper roller 77 are fashioned from type 304 stainless steel with bronze bushings to hold the heat without sparking, as well as the weight of the extremely heavy drawer assembly 12, which may weigh between about 100 and about 200 pounds (between about 45 and about 91 kgs). The bronze bushings may act as a wear surface for the stainless steel wheels 86. In an embodiment shown, the bronze used for the bushings was oil impregnated, self-lubricating bronze. Threaded portion 87 is used to attach lower rollers 76, 76′ and upper roller 77 to roller support member 78, secured with shoulder screw 89. Upper roller 77 is attached to upper mounting location 81; lower rollers 76, 76′ are attached to lower mounting locations 80, as explained below.

In an embodiment shown in FIGS. 9-11, lower roller 76 is attached to roller support member 78 at the rearward most mounting location 80′, i.e., closest to housing back 31. Lower roller 76′ can be attached to any of the other lower mounting locations 80 to control the degree to which the roller support member 78 may be extended in track member 42; when lower roller 76′ hits or engages stop member 43, further movement of the roller assembly 74 is curtailed. Thus, the more the lower roller 76′ is moved rearward, i.e., toward housing back 31, the more the roller caster assembly 74 can be extended. This adjustable feature of slide assembly 14 of the present invention is particularly advantageous. The adjustable configuration can be employed to limit extension of slide assembly 14 (and thereby upper drawer 20 of drawer assembly 12) based on oven application so that slide assembly 14 (and upper drawer 20 of drawer assembly 12) cannot be extended past the limit of the exhaust hood (not shown) associated with the oven, for example.

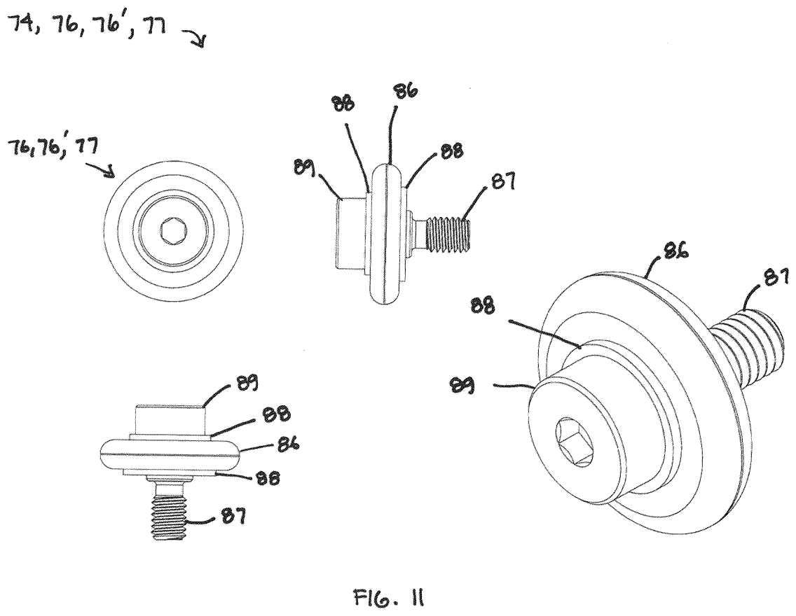

The manner in which roller assembly 74 may be extended within track member 42 is shown in FIG. 11. Upper roller 77 supported by roller support member 78 is seated within and configured to roll along upper track 45 of track member 42. In the embodiment shown, lower roller 76 is attached to roller support member 78 in the rearward most mounting location 80′, closest to housing back 31, while lower roller 76′ is mounted in forward most mounting location 80, i.e., furthest from the housing back 31. Lower rollers 76, 76′ supported by roller support member 78 are seated within and configured to roll along lower track 47 until lower roller 76′ runs into or comes into abutting relationship with stop member 43.

Roller support member 78 is configured to be mounted to the exterior of lower side 71 of upper drawer 20 in the location of holes 69 using bolts 82; however, the invention should not be viewed as being limited in this respect, since other mounting configurations could be used. Thus, when upper drawer 20 is connected to roller support member 78 in this manner and roller support member 78 is placed within track member 42, pulling on handle 24′ of upper drawer 20 will cause upper drawer 20 to be extended by virtue of the action of rollers 76, 76′, 77 and roller support member 78 in cooperation with track member 42. In addition, extending upper drawer 20 will cause lower drawer 22 to follow along and be pulled out as well in trailing fashion. In an embodiment wherein lower drawer 22 is releasably engagable with upper drawer 20, lower drawer 22, being the crumb drawer or grease tray, can be pulled out independently of upper drawer 20 by first releasing lower drawer 22 from upper drawer 20, e.g., by lifting up on handle 24 to move lower drawer 22 to the raised position and then slightly pulling on handle 24 to disengage finger members 27 from slots 39, then pulling on handle 24 to extend lower drawer 22 to the opened position.

As discussed above, upper drawer 20 and lower drawer 22 are configured with gas manifold assembly 16 in mind. FIGS. 8, 18. Specifically, upper drawer 20 and lower drawer 22 are substantially open in the back so that upper drawer 20 and lower drawer 22 can slide in and out without disturbing gas manifold assembly 16, leaving gas manifold assembly 16 in place even when burner assembly 91 is on. Unlike other charbroilers or ovens, gas manifold assembly 16 is positioned in the center of oven broiler drawer 10, as is explained more fully below, which allows the upper drawer 20 and lower drawer 22 to be moved without impacting gas manifold assembly 16.

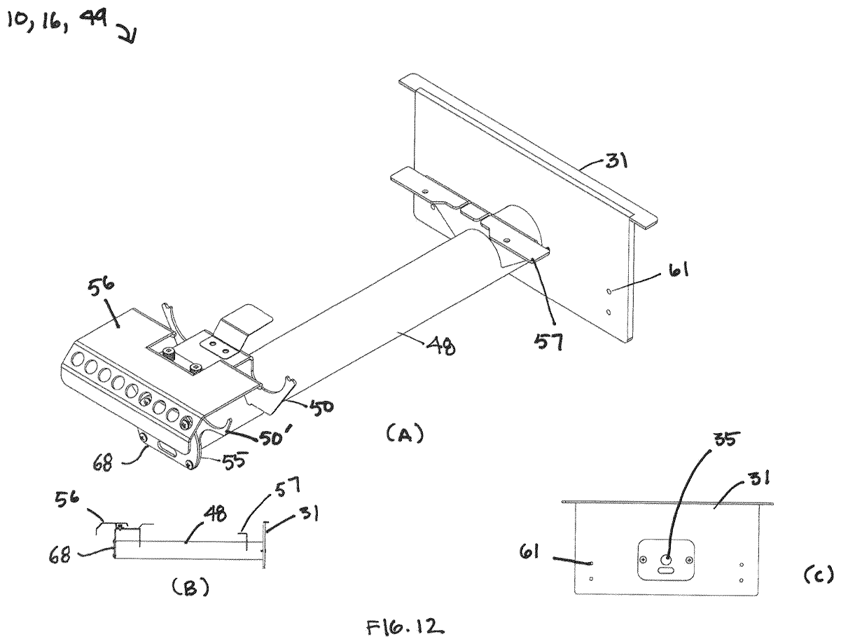

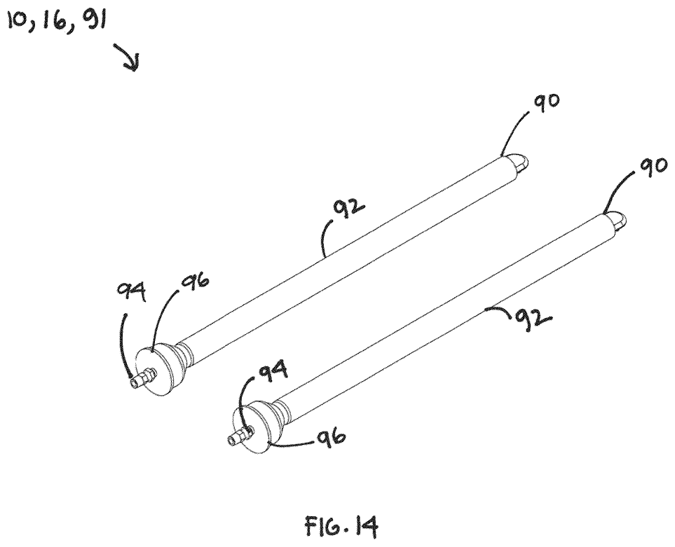

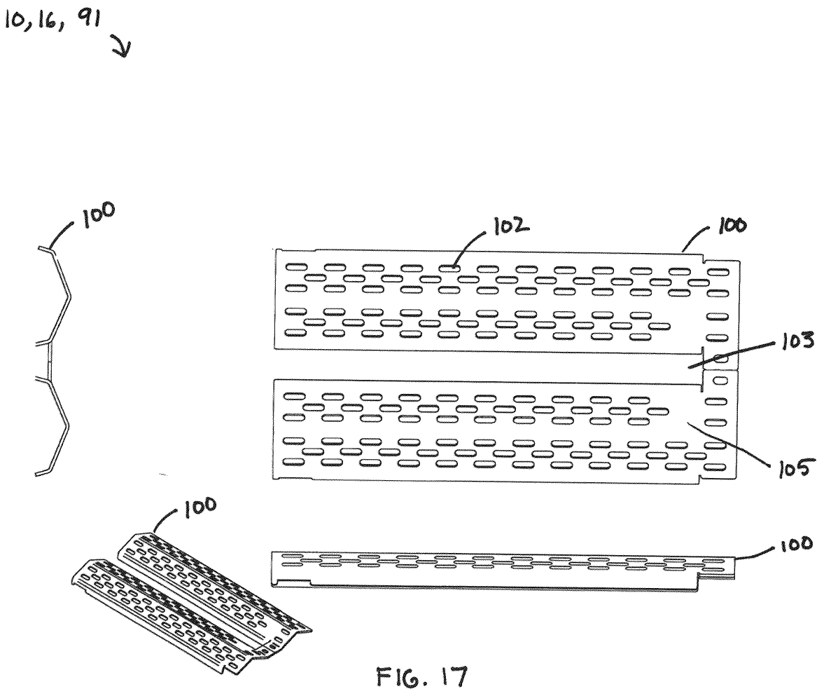

Gas manifold assembly 16 will now be described with reference to the drawings. FIGS. 12-20. Gas manifold assembly 16 comprises support assembly 49, gas supply assembly 51 and burner assembly 91.

As best seen in FIG. 12, support assembly 49 comprises support beam 48, burner brackets 50, orifice support bracket 56, manifold support plate 55 and support member or shelf 57. Support beam 48, which is substantially hollow, supports the gas supply assembly 51 and the burner assembly 91 in cantilever fashion. Support beam 48 is inserted into and secured to housing back 31, which may be considered a securing plate. In an embodiment, support beam 48 is welded to the back side of housing back 31, which may serve as support for securing support beam 48. When support beam 48 is so welded, housing back 31 is welded (e.g., attached) to housing 18 and the bottom 32 of housing 18 is bolted to a base surface, support beam 48 is cantilevered from housing back 31 and supports gas supply assembly 56 and burner assembly 91. In another embodiment, housing back 31 could be independently welded or secured to a base, such as oven floor 67, without requiring housing back 31 to be otherwise secured to housing sides 28 or bottom 32. Thus, while gas manifold assembly 16 is described herein as part of oven broiler drawer 10 of the present invention, it need not be limited in that respect and could be used in other types of ovens, grills and cooking or heating equipment.

As best seen in FIG. 8, burner brackets 50 support pipe burners 90; support beam 48 holds gas pipe 58 within it, while orifice support bracket is connected to distribution pipe 60 via pipe fittings 62 and manifold attachment plate 68 is connected to manifold support plate 55. Shelf or support member 57 and the top of orifice support bracket 56 hold radiant deflectors 100.

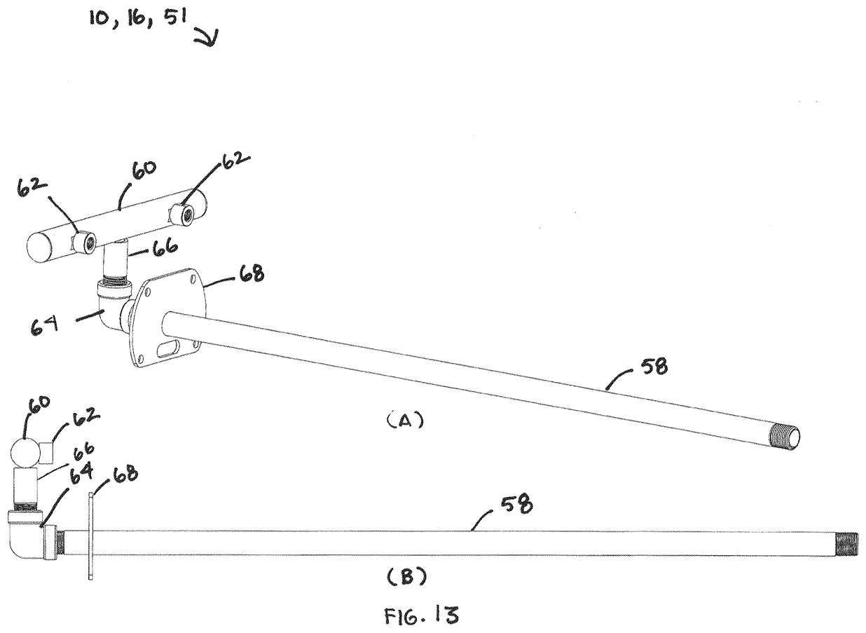

With reference to FIG. 13, gas supply assembly 51 supplies the fuel source (e.g., natural gas, LPG, propane) for the oven broiler drawer 10. Gas supply assembly 51 comprises gas pipe 58 which, in an embodiment, is connected to elbow connector 64, connector 66 and distribution pipe 66, although the invention should not be viewed as being limited in this respect since other combinations of pipes and connectors could be used as would be familiar to one of ordinary skill in the art after becoming familiar with the teachings of the present invention. Supported by support beam 48, gas pipe 58 is threaded through hole 35 in housing back 31 and extends out the back as shown in FIG. 2 where it is connected to a steady supply of gas (not shown). In the front, gas pipe 58 extends through opening 65 in manifold support plate 55.

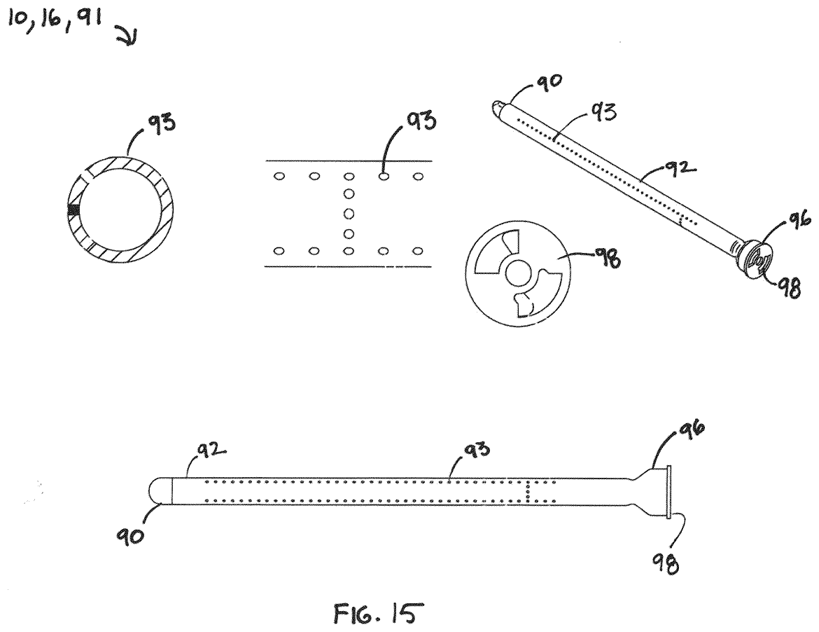

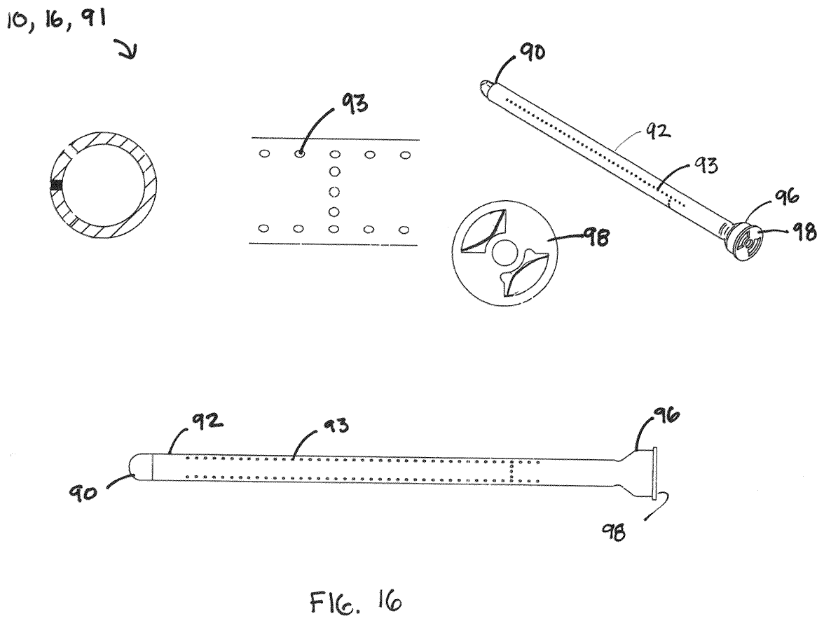

With reference to an embodiment shown in FIGS. 15-19, burner assembly 91 will now be described. Burner assembly 91 comprises pipe burner(s) 90, radiant deflector 100 and igniter 104 (FIG. 8). Pipe burners 90 comprise perforated pipe 92 which is connected to orifice holder 96 which holds burner orifice 94. In the embodiment shown, a plurality of pipe burners 90 are shown; however, the invention should not be viewed as being limited in this respect. With reference to FIGS. 15 and 16, holes 93 are arranged in an elongated “H” pattern, but the invention should not be viewed as being limited in this respect as other arrangements could be used. In an embodiment shown, holes 93 for propagation are not plugged, while some portion of burner holes 93 may be plugged. In addition, orifice holder 96 further comprises air shutter 98. Holes 93 permit gas to escape from perforated pipe 92 and air shutters 98 in orifice holder 96 allow burning activity to be controlled. By way of non-limiting example, as shown in FIG. 15, air shutter 98 is open 25 percent, while in FIG. 16, air shutter 98′ is open 100 percent. Gas flows from distribution pipe 60 into burner orifice 94 and into perforated pipe 92 and is ignited when igniter 104 is activated. Heat is then distributed across radiant deflectors 100. Heat from the burner assembly 91 as part of oven broiler drawer 10 ranges from 24,000 British thermal unit (“btu”) to about 34,000 btu (from about 25,000 kilojoule (KJ) to about 36,000 KJ).

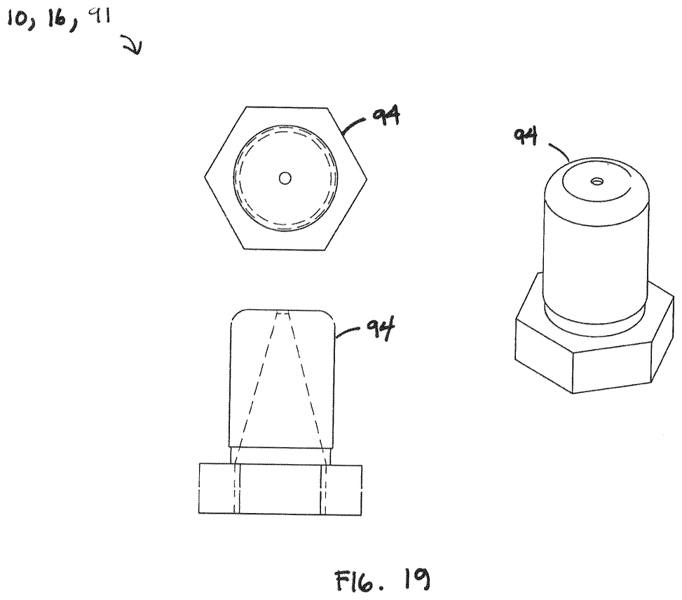

With reference to FIGS. 18-19, in an embodiment, radiant deflector 100 is shown as a single, perforated (e.g., with perforations 102) piece of stainless steel that is bent into a “hill-and-valley” configuration with space 103 between the two halves. In an embodiment shown, perforations 102 have a staggered or offset arrangement. In addition, radiant deflector 100 may include a small unperforated area 105 in radiant deflector 100. Unperforated area 105 aids in obtaining an efficient air/fuel mixture for pipe burners 90. Other configurations could be used, so the invention should not be viewed as being limited in this respect. As shown in FIG. 8, radiant deflector 100 is positioned above pipe burners 90, supported by support member 57 and orifice support bracket 56. The manner in which radiant deflector 100 is positioned within upper drawer 20 and housing 18 can be seen in FIG. 18.

In the embodiment shown in FIGS. 13-19, pipe burners 90 and radiant deflector 100 are positioned substantially parallel to support beam 48 and gas pipe 58, with radiant deflector 100 being positioned above pipe burners 90; however, other configurations are possible. The components are constructed from stainless steel of the types previously described. Pipe burners 90 are constructed from cast iron, while burner orifice 94 is made of brass.

In understanding the scope of the present invention, the term “comprising” and its derivatives, as used herein, are intended to be open ended terms that specify the presence of the stated features, elements, components, groups, and/or steps, but do not exclude the presence of other unstated features, elements, components, groups, and/or steps. The foregoing also applies to words having similar meanings such as the terms, “including,” “having” and their derivatives. Any terms of degree such as “substantially,” “about” and “approximate” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adapted to another embodiment. It should be noted that while the present invention is shown and described herein as it could be used in conjunction with a configuration of various components, it could be utilized with other configurations, either now known in the art or that may be developed in the future, so long as the objects and features of the invention are achieved, as would become apparent to persons having ordinary skill in the art after having become familiar with the teachings provided herein. Consequently, the present invention should not be regarded as limited to that shown and described herein. It is not necessary for all advantages to be present in a particular embodiment at the same time. Thus, the foregoing descriptions of the embodiments according to the present invention are provided for illustration only, and not for the purpose of limiting the invention as defined by the appended claims and their equivalents.

Having herein set forth preferred embodiments of the present invention, it is anticipated that suitable modifications can be made thereto which will nonetheless remain within the scope of the invention, including all changes that come within the meaning and range of equivalents. The invention shall therefore only be construed in accordance with the following claims.

1-20. (canceled)

21. An oven broiler drawer assembly (10), comprising:
a housing (18) defining an interior region (11) therein;
a drawer assembly (12) sized to be substantially received by the interior region (11) defined by said housing (18), said drawer assembly (12) comprising:
an upper drawer (20) defining at least an open top portion (13) and an open bottom portion (15), the open top portion (13) of said upper drawer (20) being sized to receive a grate (36) thereon; and
a lower drawer (22) defining at least an open top portion (17) and a closed bottom portion (19), said lower drawer (22) being movably mounted to said upper drawer (20) so that said lower drawer (22) may be moved with respect to said upper drawer (20) between a closed position (52) and an opened position;
a slide assembly (14) operatively associated with said housing (18) and said upper drawer (20) so that said upper drawer (20) may be moved with respect to said housing (18) between a retracted position (53) and an extended position; and
a gas manifold assembly (16) mounted to said housing (18) so that said gas manifold assembly (16) is located at a position below the grate (36) when said upper drawer (20) is in the retracted position (53).

22. The oven broiler drawer assembly (10) of claim 21, wherein said lower drawer (22) is releasably engageable with said upper drawer (20) so that when said lower drawer (22) is engaged with said upper drawer (20), said lower drawer (22) will move along with said upper drawer (20) when said upper drawer (20) is moved to the extended position and so that when said lower drawer (22) is released from said upper drawer (20), said lower drawer (22) can be moved to the opened position with respect to the upper drawer (20).

23. The oven broiler drawer assembly (10) of claim 22, further comprising a finger member (27) mounted to said upper drawer (20) and wherein said lower drawer (22) defines a slot (39) therein sized to receive said finger member (27), said finger member (27) being engaged with said slot (39) when said lower drawer (22) is engaged with said upper drawer (20), said finger member (27) being disengaged from said slot (39) when said lower drawer (22) is released from said upper drawer (20).

24. The oven broiler drawer assembly (10) of claim 23, wherein said finger member (27) is mounted to a side member (70) of said upper drawer (20), and wherein a front portion (30) of said lower drawer (22) defines said slot (39), and further wherein at least the front portion (30) of said lower drawer (22) is movable with respect to at least the side member (70) of said upper drawer (20) between a lowered position (54) and a raised position, wherein said finger member (27) is engaged with said slot (39) when the front portion (30) of the lower drawer (22) is in the lowered position (54) and wherein said finger member (27) is disengaged from said slot (39) when the front portion (30) of the lower drawer (22) is in the raised position.

25. The oven broiler drawer assembly (10) of claim 24, further comprising a first handle (24′) mounted to a front portion (34) of said upper drawer (20) and a second handle (24) mounted to the front portion (30) of said lower drawer (22), said first handle (24′) being operable to extend both the upper and lower drawers (20 and 22) together.

26. The oven broiler drawer assembly (10) of claim 24, wherein said second handle (24) is operable to move both the upper and lower drawers (20 and 22) together when the lower drawer (22) is engaged with the upper drawer (20) and wherein said second handle (24) is operable to extend only the lower drawer (22) with respect to upper drawer (20) when the lower drawer (22) is released from the upper drawer (20).

27. The oven broiler drawer assembly (10) of claim 21, wherein said housing (18) comprises a back panel (31) and wherein said gas manifold assembly (16) is mounted to the back panel (31) of housing (18).

28. The oven broiler drawer assembly (10) of claim 27, further comprising a burner assembly (91) operatively connected to said gas manifold assembly (16).

29. The oven broiler drawer assembly (10) of claim 28, wherein said burner assembly (91) comprises at least one burner (90), said burner (90) being located below the grate (36) when the upper drawer (20) is in the retracted position (53).

30. The oven broiler drawer assembly (10) of claim 21, wherein said slide assembly (14) further comprises:
a first track member (42) mounted to a first side (28) of said housing (16);
a second track member (42) mounted to a second side (28) of said housing (16);
a first roller assembly (74) mounted to a first side (70) of said upper drawer (20), said first roller assembly (74) operatively engaging said first track member (42); and
a second roller assembly (74) mounted to a second side (70) of said upper drawer (20), said second roller assembly (74) operatively engaging said second track member (42).

31. The oven broiler drawer assembly (10) of claim 30, wherein each of said first and second roller assemblies (74) further comprises:
a roller support member (78) having at least one upper roller mounting location (81) and a plurality of lower roller mounting locations (80), the plurality of lower roller mounting locations (80) extending along the roller support member (78) between a forward position and a rearward position;
an upper roller (77) mounted to the upper roller mounting location (81); and
a first lower roller 76 mounted to one of the plurality of lower roller mounting locations (80) between the forward and rearward positions, and
wherein the first and second roller tracks each comprise a stop member (43), each stop member (43) engaging the first lower roller 76 upon extension of the drawer assembly (12) to prevent the upper drawer assembly 20 from extending beyond a predetermined position, the predetermined position being defined by the position of the first lower roller (76) with respect to the forward and rearward positions.

32. The oven broiler drawer assembly (10) of claim 31, further comprising a second lower roller (76) mounted to one of the plurality of lower roller mounting locations (80) at position rearward of the first lower roller (76).
